(19) United States
(12) Patent Application Publication
(10) Pub. No.: US 2026/0241529 A1
(43) Pub. Date: Aug. 20, 2026

(54) CLAW HAMMER SUITABLE FOR VARIOUS NAILS

(71) Applicant: LU KANG HAND TOOLS INDUSTRIAL CO., LTD., Fuxing Township (TW)

(72) Inventor: YI-KUNG HUNG, Fuxing Township (TW)

(21) Appl. No.: 19/055,427

(22) Filed: Feb. 17, 2025

(51) Int. Cl. B25D 1/04

(52) U.S. Cl. CPC B25D 1/045

(57) ABSTRACT

A claw hammer suitable for various nails has a hammer, a handle and a nail extracting notch. the hammer has a first end and a second end so that the hammer can strike with the first end. The handle extends along a longitudinal direction and has two sides, two surfaces, and a bottom. The nail extracting notch has an L-shaped main body. The main body has a top edge, a bottom surface, and an extracting side away from the at least one side. Two ends of the bottom surface are respectively formed into an abutting portion and an end curve. A first extracting groove is located at a center of the extracting side, and the first extracting groove is connected with a through slot of the main body.

### BACKGROUND OF THE INVENTION

### Field of Invention

The present invention relates to a nail extracting device, and more particularly to a claw hammer suitable for various nails.

### Description of the Related Art

Currently, conventional nail pulling hammers, as shown in FIG. 13, the nail pulling hammer 60 mainly comprises a hammer 61 and a handle 62 connected to each other, and one end of the hammer 61 is provided with a striking portion 611 and another end is provided with a nail pulling portion 612 in the shape of a horn. When in use, the striking portion 611 can be used to complete the work of striking nails, and the nail pulling portion 612 can also be used to pull out nails.

However, the conventional structure described above still has the following problems in practical applications: the nail hammer 60 can only be used to pull out the shorter nails. When the nail needed to be pulled out is longer, the nail hammer 60 cannot effectively handle the task. Therefore, the applicability is poor and the use is quite inconvenient.

Therefore, it is desirable to provide a claw hammer suitable for various nails to mitigate and/or obviate the aforementioned problems.

### SUMMARY OF THE INVENTION

An objective of present invention is to provide a claw hammer suitable for various nails, which is capable of improving the above-mention problems.

### SUMMARY OF THE DISCLOSURE

In order to achieve the above-mentioned objective, a claw hammer suitable for various nails has a hammer, a handle and a nail extracting notch. the hammer has a first end and a second end so that the hammer can strike with the first end. The handle extends along a longitudinal direction and has two sides, two surfaces, and a bottom. The nail extracting notch has an L-shaped main body. The main body has a top edge, a bottom surface, and an extracting side away from the at least one side. Two ends of the bottom surface are respectively formed into an abutting portion and an end curve. A first extracting groove is located at a center of the extracting side, and the first extracting groove is connected with a through slot of the main body. The abutting portion is in an arced shape which is contracts toward the hammer; the through slot is configured for accepting a nail to be extracted, and the nail is then clamped by the first extracting groove.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional combination drawing of a first preferred embodiment of the present invention.

FIG. 2 is a partially enlarged view of the first preferred embodiment of the present invention.

FIG. 3 is a plan view of the first preferred embodiment of the present invention.

FIG. 4 is a cross-sectional view of the first preferred embodiment of the present invention.

FIG. 5 is the first action diagram of removing a long nail with the first preferred embodiment of the present invention.

FIG. 6 is the second action diagram of removing a long nail with the first preferred embodiment of the present invention.

FIG. 7 is the third action diagram of removing a long nail with the first preferred embodiment of the present invention.

FIG. 8 is the fourth action diagram of removing a long nail with the first preferred embodiment of the present invention.

FIG. 9 is a state diagram of removing a long nail with using the second nail extraction groove of the first preferred embodiment of the present invention.

FIG. 10 is a three-dimensional diagram of a second preferred embodiment of the present invention.

FIG. 11 is a three-dimensional diagram of a third preferred embodiment of the present invention.

FIG. 12 is a three-dimensional diagram of a fourth preferred embodiment of the present invention.

FIG. 13 is a conventional structure diagram.

### DETAILED DESCRIPTION OF PREFERRED EMBODIMENT

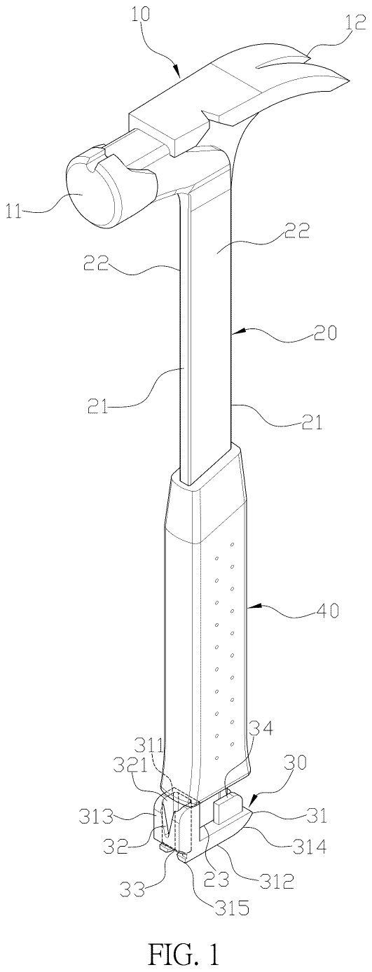

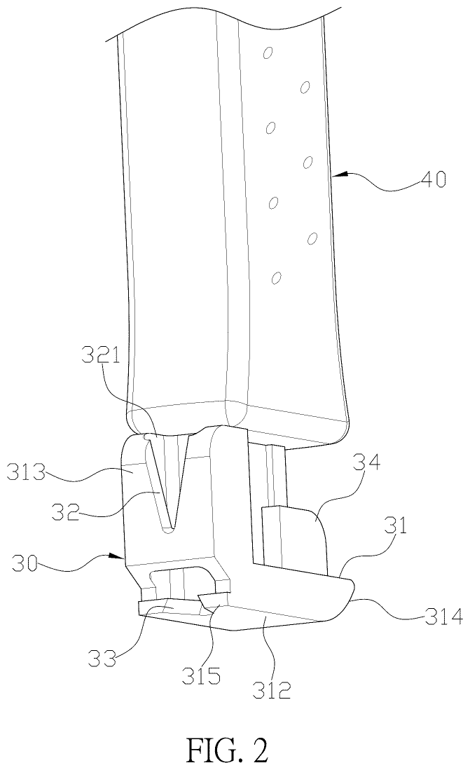

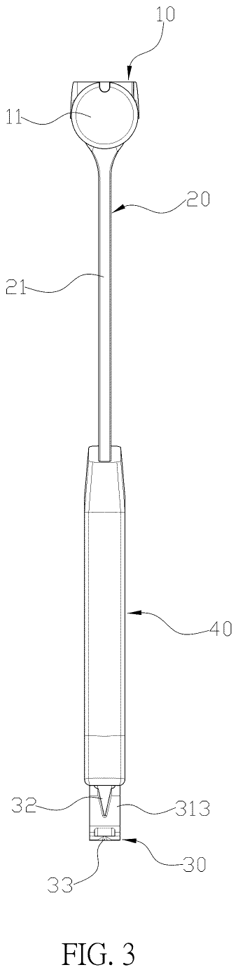

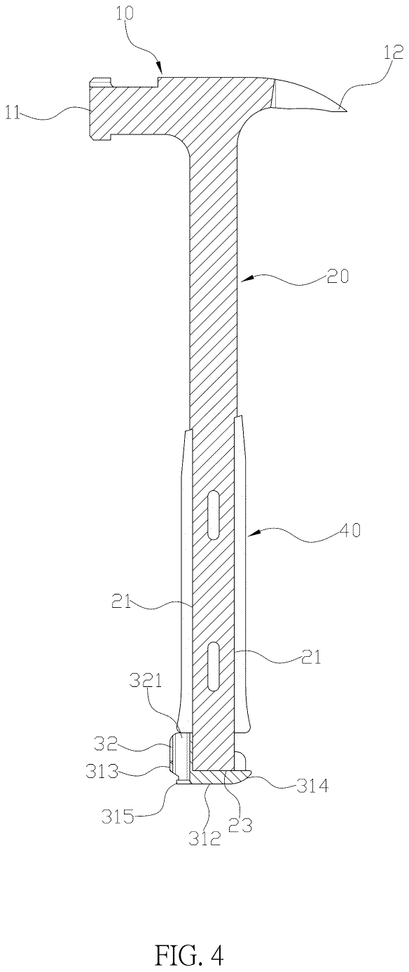

First, please refer to FIGS. 1-4, a claw hammer suitable for various nails comprises a hammer 10, a handle 20 and a nail extracting notch 30. The hammer 10 has a first end 11 and a second end 12 so that the hammer 10 can strike with the first end 11. The handle 20 extends along a longitudinal direction and has two sides 21, two surfaces 22, and a bottom 23. The nail extracting notch 30 has an L-shaped main body 31, and the main body 31 can be fixed to the handle 20 via the bottom 23 and at least one side 21. The main body 31 has a top edge 311, a bottom surface 312 and an extracting side 313 away from the at least one side 21. Two ends of the bottom edge 312 are respectively formed into an abutting portion 314 and an end curve 315 which is relatively inwardly contracted relative to the extracting side 313. Moreover, a first extracting groove 32 is located at a center of the extracting side 313, and the first extracting groove 32 is connected with a through slot 321 of the main body 31. The abutting portion 314 is in an arced shape which is contracts toward the hammer 10. The through slot 321 is configured for accepting a nail 50 to be extracted, and the nail 50 is then clamped by the first extracting groove 32. The handle 20 can provide a force to pry up and extract the nail 50. The extracting side 313, the end angle 315, the bottom edge 312 and the abutting portion 314 are used as supporting points in sequence to increase the effective distance. The nail extracting notch 30 can also be used to extract the nail 50 with a longer size, thereby greatly increasing the scope of application. The handle 20 can provide a force to pry up and extract the nail 50, and the extracting side 313, the end angle 315, the bottom edge 312 and the abutting portion 314 are used as supporting points in sequence to increase the effective Leverage distance, therefore, the nail extracting notch 30 can also be used to extract the nail 50 with a longer size, thereby greatly increasing the scope of application.

Moreover, the hammer 10, the handle 20 and the nail extracting notch 30 are made of metal, and the hammer 10, the handle 20 and the nail extracting notch 30 are integrally formed.

In addition, the hammer 10, the handle 20 and the nail extracting notch 30 are made of metal, and the nail extracting notch 30 is fixed to the handle 20 by welding.

Also, wherein the first end 11 of the hammer 10 is a striking portion, and the second end 12 is a horn-shaped nail-pulling portion.

Furthermore, the first end 11 and the second end 12 of the hammer 10 are both are both a striking portion, and the second end 12 is a pointed cone.

Moreover, the handle 20 is covered with a rubber sleeve 40.

Besides, the extracting side 313 and the end curve 315 are on the same side as the first end 11 of the hammer 10.

Additionally, the extracting side 313, the end angle 315 are on the same side as the second end 12 of the hammer 101.

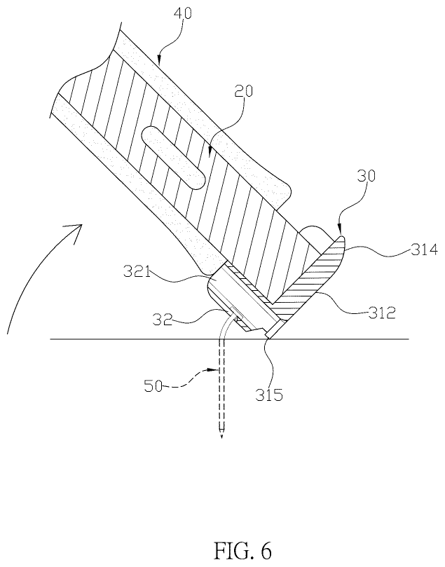

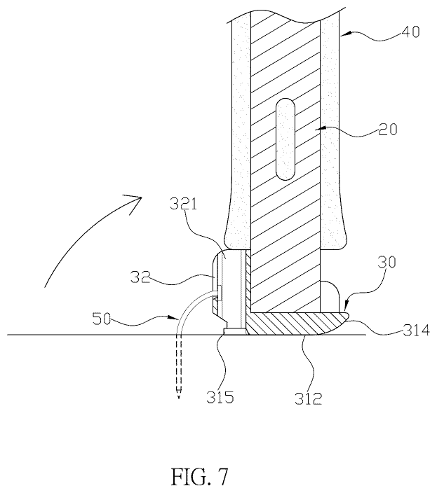

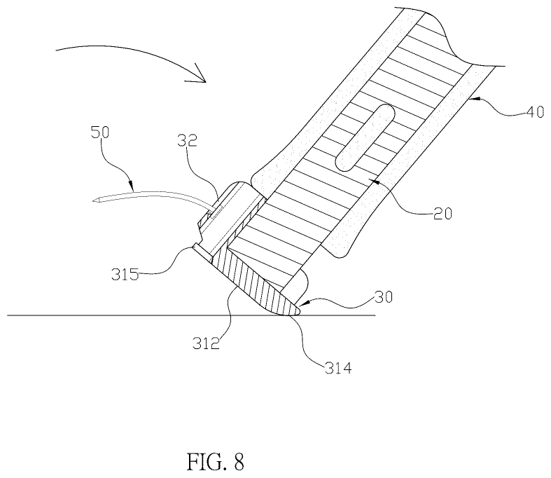

Moreover, the first extracting groove 32 is a V-shaped groove, so that through slot 321 can penetrate the top edge 331 of the main body 31, as shown in FIGS. 1-9.

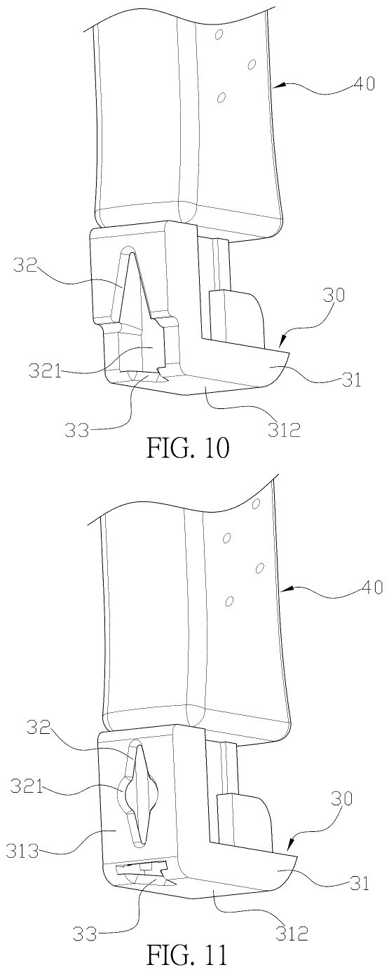

Also, the first extracting groove 32 is an inverted V-shaped groove, so that the slot 321 can penetrate the bottom edge 312 of the main body 31, as shown in FIG. 10.

Alternatively, the first extracting groove 32 is designed in a diamond shape so that the through slot 321 can penetrate the extracting side 313 in a center of the first extracting groove 32.

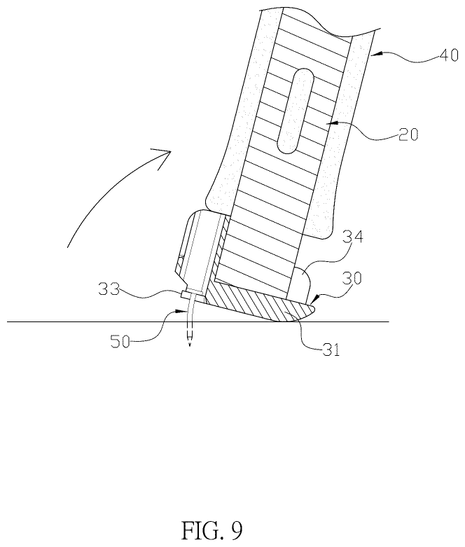

Furthermore, the main body 31 further comprises a second nail extracting groove 33 passing through the bottom edge 312, and the second nail extracting groove 33 is configured for the nail 50 in a shorter size, as shown in FIG. 9.

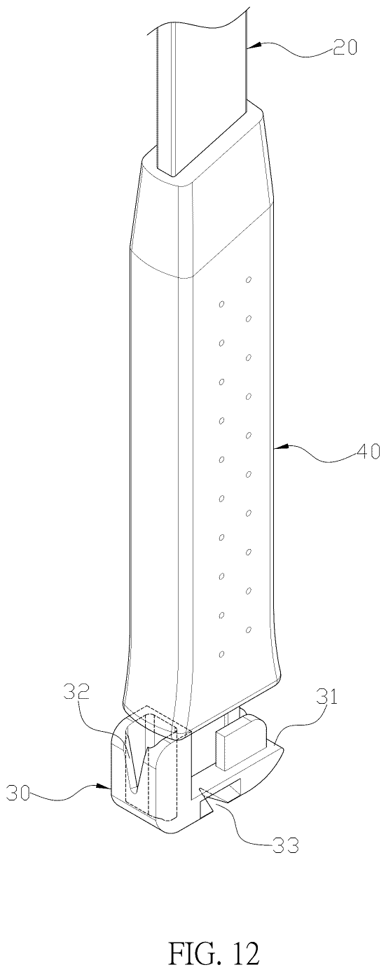

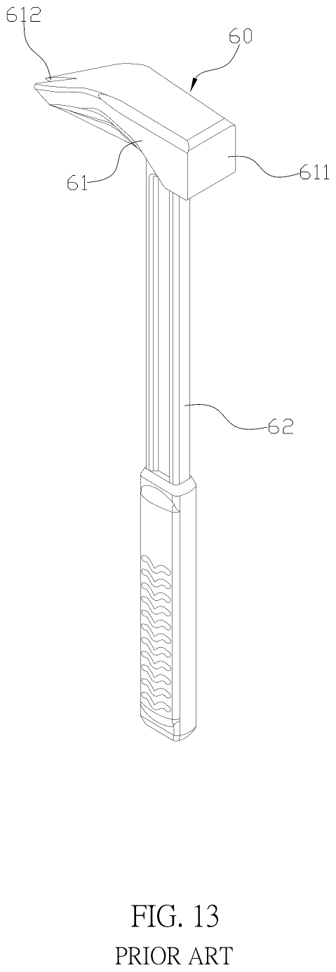

Also, the second nail extracting groove 33 is disposed on any side of the main body 31, as shown in FIGS. 1 and 12.

Additionally, two plates 34 extend from the main body 31, and the two plates 34 are connected to the two surfaces 22 of the handle 20, which increases the combined area of the main body 31 and the handle 20.

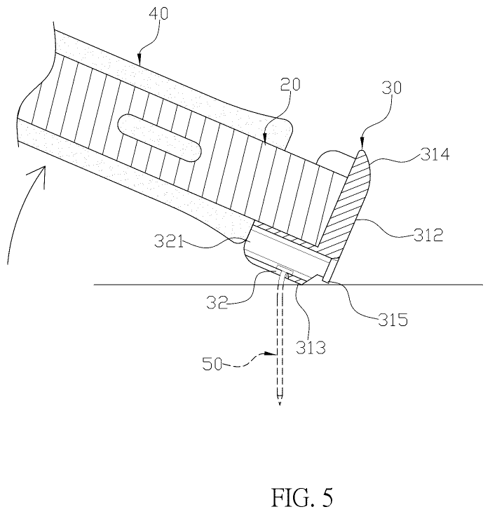

When in actual application, in addition to completing the work of hammering the nail 50 by the first end 11 of the hammer 10, the first extracting groove 32 of the nail extracting notch 30 can be used to directly extract short nails. When the nail needs to be removed is longer in size, the first extracting groove 32 is used to clamp the nail 50, and the extracting side 313 is pressed against a fixed surface such as a wall or the ground, and then the handle 20 is rotated in the opposite direction to pry up and remove the nail 50. During the rotation of the handle 20, the extracting side 313, the end curve 315, the bottom surface 312 and the abutting portion 314 are used as supporting fulcrums in sequence, as shown in FIGS. 5 to 8, so that the effective leverage distance for removing the nail 50 can be extended to the maximum. Therefore, the longer nail 50 can also be smoothly extracted, so as to achieve the actual effect of being applicable to nails 50 of various sizes such as short nails and long nails.

The structure of the above-mentioned specific embodiment can obtain the following benefits: the nail extracting notch 30 can be used for extracting the nail 50 of various sizes such as long and short nails, so it is not only suitable for use, but also can effectively reduce the number of hand tools carried by the user, and there is no need to make various hand tools changing during work, which is very convenient to use.

Although the present invention has been explained in relation to its preferred embodiment, it is to be understood that many other possible modifications and variations can be made without departing from the spirit and scope of invention as hereinafter claimed.

What is claimed is:

1. A claw hammer suitable for various nails comprising: a hammer, a handle and a nail extracting notch; wherein
the hammer has a first end and a second end so that the hammer can strike with the first end;
the handle extends along a longitudinal direction and has two sides, two surfaces, and a bottom; and
the nail extracting notch has an L-shaped main body, and the main body can be fixed to the handle via the bottom and at least one side; the main body has a top edge, a bottom surface, and an extracting side away from the at least one side; two ends of the bottom surface are respectively formed into an abutting portion and an end curve which is relatively inwardly contracted relative to the extracting side; a first extracting groove is located at a center of the extracting side, and the first extracting groove is connected with a through slot of the main body; the abutting portion is in an arced shape which is contracts toward the hammer; the through slot is configured for accepting a nail to be extracted, and the nail is then clamped by the first extracting groove.

2. The claw hammer suitable for various nails as claimed in claim 1, wherein the hammer, the handle, and the nail extracting notch are made of metal, and the hammer, the handle, and the nail extracting notch are integrally formed.

3. The claw hammer suitable for various nails as claimed in claim 1, wherein the hammer, the handle, and the nail extracting notch are made of metal, and the nail extracting notch is fixed to the handle by welding.

4. The claw hammer suitable for various nails as claimed in claim 1, wherein the first end of the hammer is a striking portion, and the second end is a horn-shaped nail-pulling portion.

5. The claw hammer suitable for various nails as claimed in claim 1, wherein the handle is covered with a rubber sleeve.

6. The claw hammer suitable for various nails as claimed in claim 1, wherein the extracting side and the end curve are on the same side as the first end of the hammer.

7. The claw hammer suitable for various nails as claimed in claim 1, wherein the extracting side and the end curve are on the same side as the second end of the hammer.

8. The claw hammer suitable for various nails as claimed in claim 1, wherein the first extracting groove is a V-shaped groove, so that the through slot can penetrate the top edge of the main body.

9. The claw hammer suitable for various nails as claimed in claim 1, wherein the first extracting groove is an inverted V-shaped groove, so that the through slot can penetrate the bottom edge of the main body.

10. The claw hammer suitable for various nails as claimed in claim 1, wherein the first extracting groove is designed in a diamond shape so that the slot can penetrate the extracting side in a center of the first extracting groove.

11. The claw hammer suitable for various nails as claimed in claim 1, wherein the main body further comprises a second nail extracting groove which passes through the bottom edge.

12. The claw hammer suitable for various nails as claimed in claim 11, wherein the second nail extracting groove is disposed on any side of the main body.

13. The claw hammer suitable for various nails as claimed in claim 1, wherein two plates extend from the main body, and the two plates are connected to the two surfaces of the handle, which increases the combined area of the main body and the handle.
